(19) United States
(12) Patent Application Publication
(10) Pub. No.: US 2016/0016330 A1
(43) Pub. Date: Jan. 21, 2016

(54) Proceeding in Connection with Stone Production and a Plant for the Proceeding

(71) Applicant: NATSTONE AB, Gothenburg (SE)

(72) Inventor: Jan-Inge Lindeberg, Styrsö (SE)

(73) Assignee: Natstone AB, Göteborg (SE)

(21) Appl. No.: 14/773,335

(22) PCT Filed: Mar. 4, 2014
(86) PCT No.: PCT/SE2014/050267

§ 371 Date: Sep. 5, 2015

(30) Foreign Application Priority Data
Mar. 5, 2013 (SE) 1350263-8

(51) Int. Cl. B28D 1/02; B28D 7/00

(52) U.S. Cl. CPC B28D 1/02; B28D 7/00

(57) ABSTRACT

The invention concerns a proceeding for the production of slab-shaped stone products (1) from blocks (2) of natural stone. According to the invention, occurring stresses in the stone block (2) are removed, before saw-cutting of said stone block (2) into thinner slabs (1), by drying the stone block (2) internally by utilising a micro wave dryer (3) and thereby attaining stress relief of the same. The invention also concerns a plant for carrying out a proceeding according to the invention.

The present invention concerns a proceeding for the production of disc-shaped stone products from blocks of natural stone as well as a plant for carrying out a said proceeding.

By SE 470 185B, it is previously known, in connection with production of disc-shaped stone products, to increase the strength to allow the sawing of thin discs from the stone. Also the proper stone product as well as means therefor are intended to be protected thereby. However, said proceeding means that much impregnating agent is consumed and that the same transforms into a stage wherein it is difficult to recover and reuse. If instead it would be possible to increase the strength of the stone product without needing to impregnate with agent which becomes costly in the long run, a lot would be gained.

Therefore, the main object of the present invention is primarily to solve, among other things, said problems in a technically efficient way and also allow to also solve it economically advantageously in a simple way.

Said object is achieved by means of a proceeding according to the present invention, which essentially is characterized in that occurring stresses in the stone block are removed, before saw-cutting of said stone block into thinner slabs, by drying the stone block internally by utilising a microwave dryer and thereby attaining stress relief of the same.

The invention also concerns a plant intended to be used in the realisation of a proceeding for the production of slab-shaped stone products from blocks of natural stone according to the present invention.

Thereby, a proceeding according to the invention is made possible to be realised in a simple and cost-saving way.

Said object is achieved by means of a plant according to the present invention, which essentially is characterized in that a production line comprises microwave dryer apparatus, heating apparatus for the heating of stone blocks, as well as cooling means for stone blocks before sawing tool, as well as grinding- and/or polishing tool for the slabs.

The invention is described in the following, reference being made to the accompanying drawings, in which

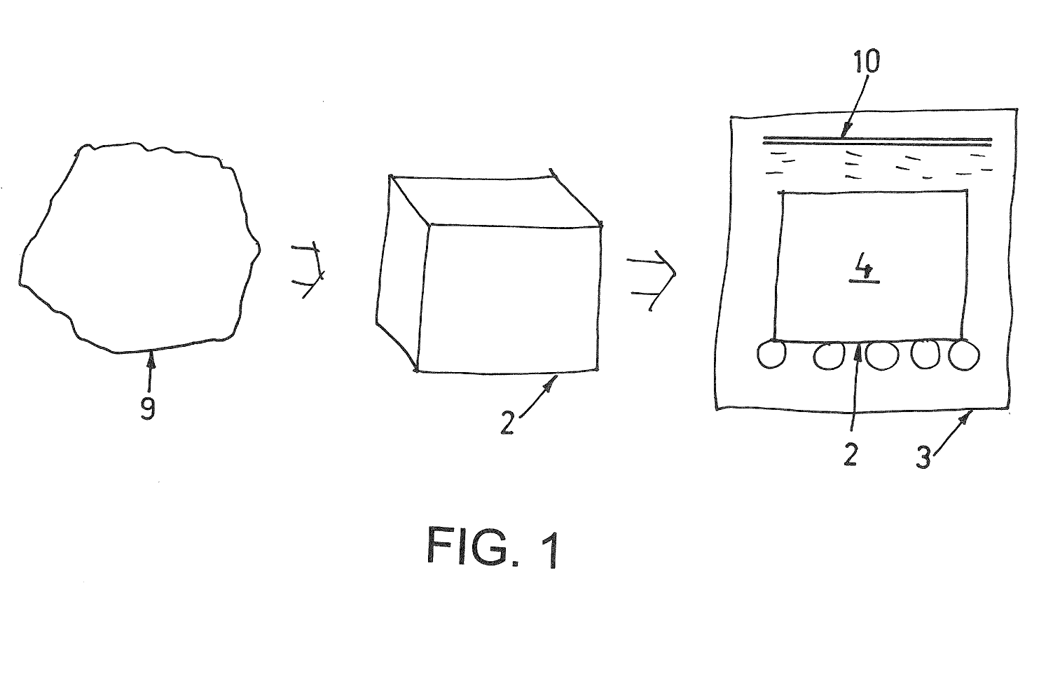

FIGS. 1-4 schematically show a proceeding for the production of slab-shaped stone items, wherein

FIG. 1 shows the formatting of raw stone into manageable size as well as subsequent drying of the stone in microwave oven,

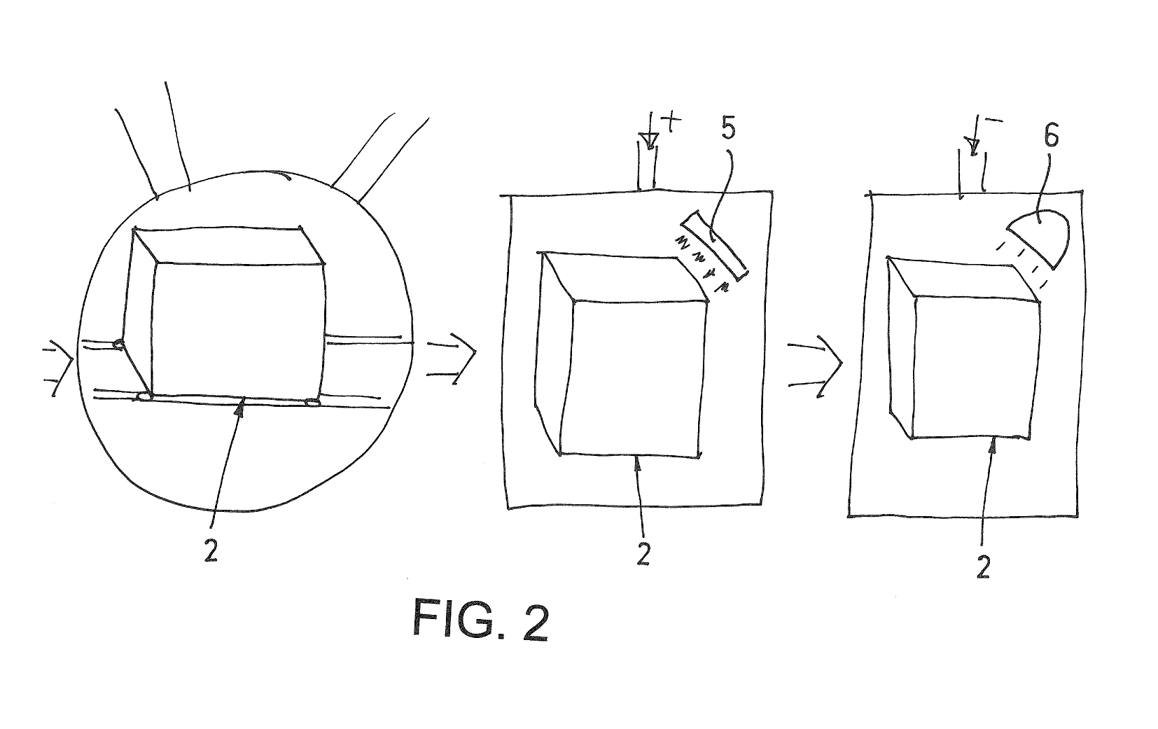

FIG. 2 shows subsequent drying and cooling, respectively, of formatted stone block,

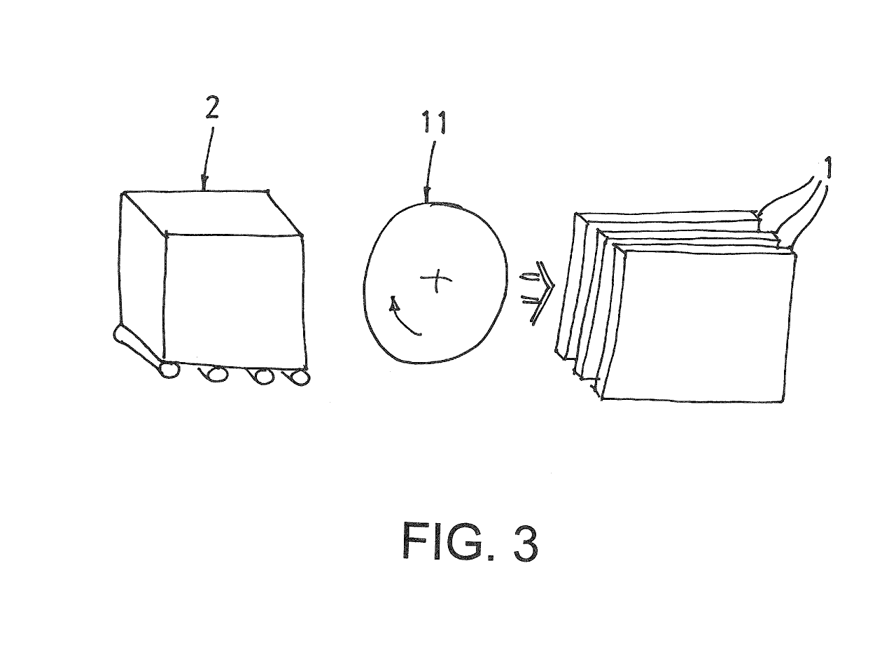

FIG. 3 shows sawing of stone into slab-shaped stone items, and

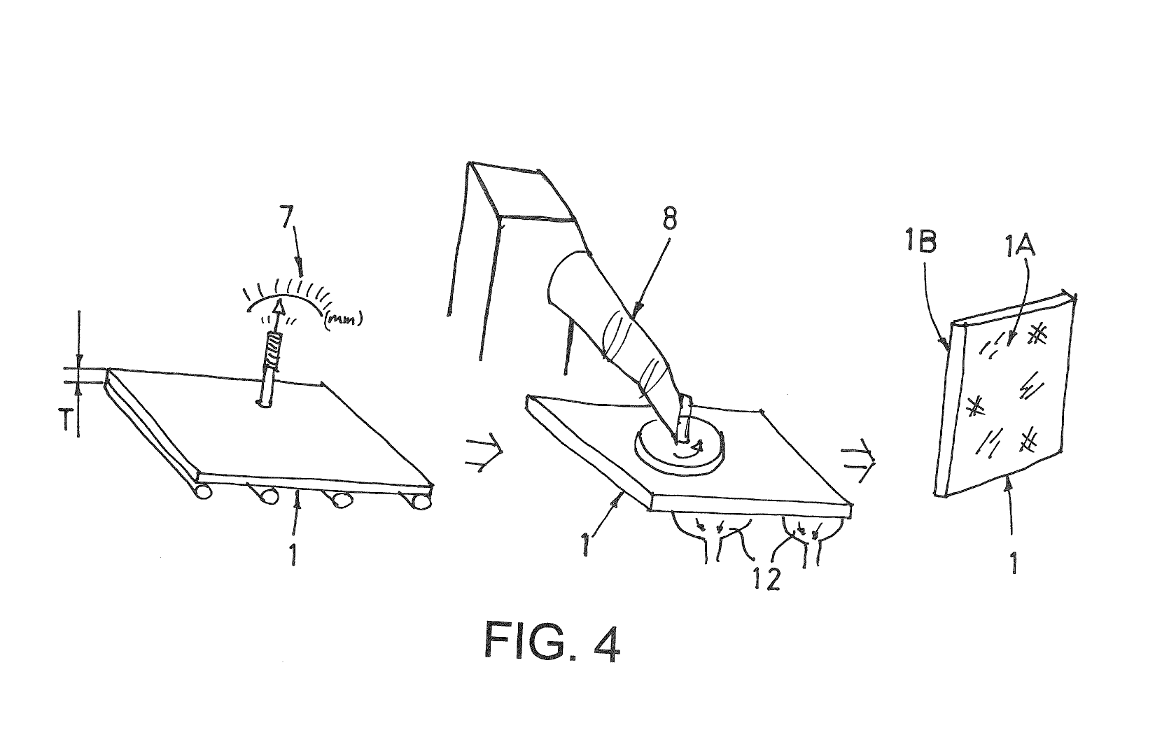

FIG. 4 shows subsequent calibration and grinding/polishing proceeding of slab-shaped stone item.

The invention concerns a proceeding for the production of slab-shaped stone products 1 from block 2 of natural stone which comprises that occurring stresses are removed in said stone block 2 in thinner slabs 1. Said proceeding means that the stone block 2 is dried, thereby attaining stress relief of the stone block 2. According to the invention, the stone block 2 is dried internally therein by utilising a microwave dryer 3 in which the stone block 2 is retained a certain time, thereby attaining stress relief of the same.

By containing the stone block 2 internally in a microwave oven 3 for a certain time, the entire stone block 2 is efficiently dried internally 4.

After said drying in microwave oven 3, the stone block 2 is heated to at least 100° C. for a certain time. Preferably, the stone block 2 is heated and dried further by utilising infrared radiation 5 of the stone block 2.

After said heating of the stone block 2, the stone block 2 in question is cooled to approx. room temperature 18-25° C. This cooling is attained differently fast depending on the sort of stone concerned and it has to be ensured that the stone is not cooled too fast so that it cracks or crackles in another way. Preferably, said cooling is effected together with ultrasound treatment 6 of the stone block 2 in question. Namely, ultrasound generates oscillation in the stone material. The treatment and actuation of the stone block 2 provided, and which are schematically shown in FIG. 2, are conditioned to occur in a climate-conditioned space, so that correct air humidity, heat, etc., are achieved and maintained according to the requirements and conditions made so that the proceeding should work to the full extent.

Next, the stress-relieved stone block 2 can be saw cut into the desired numbers and with intended thickness T, preferably to approx. 4 mm thin slabs 1 before calibration 7 of the thickness T of the slabs 1 and subsequent grinding and/or polishing 8 of the slabs 1, at least on one flat face 1A, 1B thereof. Clamping of the slabs 1 may be effected by vacuum suction means 12 of known type.

The proceeding is suitably realised in a plant therefor, and which may comprise all proceeding sub-steps as indicated above. The treatment is at least comprised before the sawing in a dry and closed environment so that the stone blocks 2 unnecessarily are not exposed to moisture when the stone blocks 2 have been dried and made stress-free.

The cause for the stresses in a stone block is the water therein, and in stones, there are built-in stresses since when the stone was formed. By heating the stone, the stresses are removed, and by means of the micro, the stone is dried from within, whereby the water and the stresses disappear from the stone thanks to said heating process.

However, said releases from stress and removal of the water from stone cannot be attained by storing the stone in a dry environment a certain time.

To utilise IR heating is both economically advantageous and time-saving. The stone is dried continuously in a line and does not need to enter a closed chamber. First, a large stone block is treated by means of micro and then thin (4 mm) slabs are sawn out from the block. The slabs become, because of wet sawing, wet and therefore they need to be dried. This is made using IR dryer. This is simple since they can be run in the open air on a track and no micro is required.

Normally, thin slabs, e.g. 4 mm, cannot be sawn. Below 10 mm, the rejection increases logarithmically for each millimetre. Thus, for the last millimetre, there is 90% wastage, which is not good.

However, the Techstone patent SE 470 185 B made this possible, but it became too expensive.

Using ultrasound treatment of stone blocks, it is attained that the stresses of the stone blocks disappear.

A plant suitable to use in the realisation of a proceeding for the production of slab-shaped stone products 1 from block 2 of natural stone according to the invention means that a production line comprises microwave dryer apparatus 10, heating apparatus 5 for the heating of stone block 2, as well as cooling means 6 for stone block 2 before sawing tool 11, as well as grinding- and/or polishing tool 7 for the slabs 1.

Next, after the stress which is present in the piece of natural stone 9 now having been removed, it is accordingly made possible, with no obstacle, to saw out thin slabs 1 in the stone block 2 provided and without the slabs 4 cracking. If the stone block 2 has sufficient dryness, a certain or some drying steps may be omitted with no obstacle, for example that the drying using the infrared radiation 5 is omitted.

The stone material may be sawn and polished in dry state without added liquid, for example using diamond cutting tool. Using IR, the stone is heated up to 100° C. If the stone is sufficiently dry after treatment with micro waves, the IR treatment of the stone may be omitted. The most important is that the stone is treated by micro waves, and after that is cooled down to intended temperature, room temperature.

Fields of application for the produced stone slabs 1 and the sizes thereof may be varied according to needs and supply of stone. For instance, the stone slabs 1 may be produced with the dimensions 2 times 1 m and 4 mm thin. The fields of application may be as cladding, for example on buildings, and as fixtures in buildings and in vehicles.

The nature and the function of the device should clearly have been seen from what is described above and shown in the drawings.

The invention is naturally not limited to the embodiments described above and shown in the accompanying drawings. Modifications are feasible, particularly as for the nature of the different parts, or by using an equivalent technique, without departing from the protection area of the invention, such as it is defined in the claims.

1.-8. (canceled)

9. A method of producing slabs from blocks of natural stone, comprising:
removing stress in a block before saw-cutting the block into slabs thinner than the block by drying the block internally.

10. The method of claim 9, wherein block is internally dried by disposing the block in a microwave oven for a certain time.

11. The method of claim 9, further comprising, after drying the block internally, heating the block to at least 100° C.

12. The method of claim 11, wherein the block is heated by infrared radiation.

13. The method of claims 11, further comprising cooling the block to room temperature at a rate dependent on type of stone of the block.

14. The method of claim 13, wherein cooling the block includes applying ultrasound to the block.

15. The method of claim 9, further comprising sawing slabs from a block after removing stress in the block, wherein the slabs have thicknesses of about 4 millimeters, and the slabs are sawn before calibrating the thicknesses of the slabs and grinding or polishing the slabs.

16. A production line for producing slabs from blocks of natural stone according to the method of claim 13, comprising:
a microwave dryer configured to dry blocks internally;
a heater configured to heat blocks to at 100° C.; and
a cooler configured to cool blocks to room temperature at respective rates dependent on type of stone of the respective block.

17. The production line of claim 16, wherein the cooler is further configured to apply ultrasound to blocks.
